(19) United States
(12) Patent Application Publication
(10) Pub. No.: US 2022/0410856 A1
(43) Pub. Date: Dec. 29, 2022

(54) TIP-OVER PREVENTION FOR LOAD CARRYING VEHICLES

(71) Applicant: WINK ANTI TIP, LLC, Evansville, IN (US)

(72) Inventor: James W. Wink, Evansville, IN (US)

(73) Assignee: WINK ANTI TIP, LLC, Evansville, IN (US)

(21) Appl. No.: 17/899,569

(22) Filed: Aug. 30, 2022

Related U.S. Application Data
(63) Continuation-in-part of application No. 16/731,384, filed on Dec. 31, 2019, now Pat. No. 11,498,469.
(60) Provisional application No. 62/786,990, filed on Dec. 31, 2018.

(51) Int. Cl. B60T 8/24; B60T 8/1755; B60P 1/04; G08B 21/18

(52) U.S. Cl. CPC B60T 8/243; B60T 8/17551; B60T 8/17554; B60P 1/045; G08B 21/182; B60T 2230/03

(57) ABSTRACT

A tip-over prevention system for vehicle, including a tilt detector operably coupled to a rear axle of the vehicle. The tilt detector is configured to detect a current tilt. A tilt controller is placed in electronic communication with the tilt detector and the tilt controller is placed in electronic communication with a braking controller that is configured to activate a braking system of the vehicle. The tilt controller is configured to determine if the current tilt exceeds a preset tilt threshold. In response to the current tilt exceeding the preset tilt threshold, the tilt controller is configured to signal the braking controller to activate the braking system of the vehicle.

### CROSS-REFERENCE TO RELATED APPLICATIONS

The present application is a continuation-in-part of U.S. application Ser. No. 16/731,384, filed Dec. 31, 2019, and claims the benefit of U.S. Provisional Patent Application No. 62/786,990, filed Dec. 31, 2018, the entire contents of which are expressly incorporated herein by reference.

### TECHNICAL FIELD OF THE INVENTION

The present application relates to vehicle tip-over prevention. More particularly, the present application relates to tip-over prevention for cargo hauling vehicles, such as dump trailers, dump trucks and articulating dump trucks, cement trucks, tanker trucks, and the like.

### BACKGROUND

Vehicle turn overs, also referred to as tip-overs, are economically costly and can result in injury or death to operators and any passengers within the vehicle. A load carrying vehicle tip-over can result in damage to the vehicle or trailer, the load may be spilled and lost, and a considerable amount of labor may be required to right the vehicle.

Many factors influence the likelihood of a vehicle tip over including: the particular terrain the vehicle will be used upon; the skill level of the driver; the center of gravity of the vehicle; how the center of gravity will be altered during any raising and lowering of a dumping bed; and whether the load the vehicle is carrying will easily shift. Some exemplary loads which are more prone to shift including liquids, sand, ore, coal, gravel, etc.

Dumping vehicles can be prone to tip-overs. Dumping vehicles include a cargo body that can raise and/or tilt to provide for the unloading of cargo therefrom. Exemplary dumping vehicles include, dump trucks, dump trailers, and articulated dump trucks. As the cargo body is raised, the center of gravity of the vehicle is raised. Such an increased center of gravity yields a vehicle more prone to tilt and tip-over.

It is believed that tip-overs are more likely to occur on uneven terrain and/or soft ground into which one or more wheels may sink. Mining operations, agricultural operations, and construction sites can subject vehicles to highly undesirable terrain and soft ground. Concrete mixers, off-road tankers and water trucks (e.g., commonly referred to as Buffalos), dump trucks, and articulated dump trucks are some exemplary vehicles that are often subject to harsh uneven terrain and can experience tip-overs.

It can be difficult for an operator to detect an unsafe tilt situation and to take corrective action prior to a tip-over. In vehicles where there is an articulation or pivot between the cab and the trailer or bed (e.g., dumping trailers, some off-road tankers, and articulated dump trucks), the driver is unable to feel the degree of tilt the cargo body is subjected to as the articulation or pivot separates the cab and the operator therein, from the tilt. When the vehicle is reversed, as commonly occurs prior to loading or unloading of the cargo body, the chassis of the cargo body will encounter any obstacle first. However, in many instances, the cargo body and/or load may obstruct or partially obstruct the operator's view. In such a situation, the driver can neither see nor feel that the cargo body is encountering an obstacle. The operator may be unaware of an unsafe tilt until a tip-over occurs.

It has been discovered that the suspension of the vehicle can hide the actual tilt the cargo body is subjected to, until the degree of tilt is such that the axle of the vehicle begins to lift from the ground. When the axle begins to lift from the ground, it may be too late to prevent a tip-over.

Vehicles with an inherently high center of gravity are typically more prone to tip-overs. Double decker buses, as are commonly utilized in parts of South and Central America on rural roads with rough terrain, are one such exemplary vehicle with a high center of gravity. Especially in mountainous regions, tip-overs can result in significant injuries or numerous deaths. Should such an accident occur in a remote area, it can take a substantial amount of time for rescue crews to assist those in the crash or to even be aware that such a tip-over occurred.

Many systems of the prior art utilize operator warnings. Such systems rely upon the operator to quickly recognize the warning and take corrective action to remediate the situation. Unfortunately, many operators may fail to respond and/or take corrective action in response to the warning. Even when the operator is alert and appropriately responds to the warning, they may not respond quickly enough to prevent a tip-over. In some cases, the operator may actually choose to ignore such warnings or may not understand what the warning means (e.g., in the case of a novice driver or when there are multiple similar warning systems in place on the vehicle).

Therefore, further technological developments are desirable in this area.

### SUMMARY

One embodiment of the present application A tip-over prevention method for a load carrying vehicle. The method includes providing a load carrying vehicle having a chassis, a braking system, and a cargo body. The method includes mounting a tilt detector to the chassis of the load carrying vehicle at a location below the cargo body. The method further includes detecting a current tilt at the chassis and activating the braking system of the load carrying vehicle in response to the current tilt exceeding a predetermined tilt threshold.

Mounting the tilt detector to the chassis can include attaching the tilt detector to an axle. The axle can be a rearmost axle of the load carrying vehicle.

The method can further include placing a controller in electronic communication with the tilt detector and the braking system. The controller can be configured for: comparing the current tilt and the predetermined tilt threshold; and providing an activate signal to the braking system in response to the current tilt exceeding the predetermined tilt threshold.

Providing a load carrying vehicle can include providing one of a mixer vehicle and a tanker truck.

The method can further include mounting a second tilt detector to a forward axle of the load carrying vehicle, and the second tilt detector can be configured to detect a second current tilt. The current tilt can be a current lateral tilt and the second current tilt can be a second lateral tilt. This method can include activating the braking system of the load carrying vehicle in response to the second current lateral tilt exceeding a predetermined second tilt threshold.

The method can further include providing a user activated override within a cab of the load carrying vehicle and deactivating the braking system of the load carrying vehicle in response to 1.) the override being activated and 2.) in response to a transmission of the load carrying vehicle being placed in reverse.

Detecting the current tilt can include detecting a current lateral tilt and detecting a current vertical tilt. The method can include comparing the current lateral tilt to a predetermined lateral tilt threshold and comparing the current vertical tilt to a predetermined vertical tilt threshold. This method can include activating the braking system of the load carrying vehicle in response at least one of: 1.) the current lateral tilt exceeding the predetermined lateral tilt threshold and 2.) the current vertical tilt exceeding the predetermined vertical tilt threshold.

Providing the load carrying vehicle can include providing an articulated dump truck, which has a piston configured to raise a portion of the cargo body, a fluid release valve is operably coupled with the piston, and the tilt detector is mounted to a rearmost axle of the articulated dump truck.

The method can further include determining if a transmission of the articulated dump truck is placed in a forward gear. In response to the articulated dump truck being placed in a forward gear, the controller can fail to (e.g., does not) provide the activate signal to the braking system.

The predetermined lateral tilt threshold can have a value that is less than a value of the predetermined vertical tilt threshold.

The method can further include locating a second tilt detector at the cargo body of the articulated dump truck; detecting a second current lateral tilt at the cargo body and activating the fluid release valve in response to the second current lateral tilt exceeding a predetermined second lateral tilt threshold (thereby releasing the fluid from the piston).

Another form of the present application is directed to a method for vehicle tip-over prevention for a load carrying vehicle. This method includes providing a vehicle including a forward axle, a rearward axle, a chassis, a braking system, and a liquid cargo body. The method includes locating a tilt detector at the chassis of the vehicle at a location below at least a portion of the liquid cargo body, the tilt detector being configured to detect a current tilt. The method includes automatically activating the braking system of the vehicle in response to the current tilt exceeding a predetermined tilt threshold.

The liquid cargo body can be one of a mixer barrel and a fluid storage tank.

The method can include mounting a second tilt detector to the forward axle of the vehicle (e.g., the second tilt detector is configured to detect a second current tilt) and activating the braking system of the vehicle in response to the second current tilt exceeding a predetermined second tilt threshold.

The method can further include mounting a third tilt detector to the rearmost axle of the vehicle. The third tilt detector can be configured to detect a third current tilt. The current tilt, the second current tilt, and the third current tilt can be lateral tilts. The method can include activating the braking system of the vehicle in response to the third current tilt exceeding a predetermined third tilt threshold.

The predetermined tilt threshold, the predetermined second tilt threshold, and the predetermined third tilt threshold can be selected from the range of 1 to 5 degrees of lateral tilt. The predetermined tilt threshold, the predetermined second tilt threshold, and the predetermined third tilt threshold can approximate 2 degrees of lateral tilt. The predetermined tilt threshold, the predetermined second tilt threshold, and the predetermined third tilt threshold can be an angle of lateral tilt selected from the range of 1 to 3 degrees of lateral tilt.

The method can include activating an alarm in response to the current tilt exceeding the predetermined tilt threshold. Activating the braking system can includes engaging a parking brake of the vehicle. The method can include deactivating the alarm and disengaging the parking brake in response to the current tilt being less than the predetermined tilt threshold.

Another form of the present application is directed to a tip-over prevention system for a vehicle. The system includes a tilt detector operably coupled to a rear axle of the vehicle, and the tilt detector is configured to detect a current tilt. A tilt controller is placed in electronic communication with the tilt detector and a braking controller. The braking controller is configured to activate a braking system of the vehicle. The tilt controller is configured to determine if the current tilt exceeds a preset tilt threshold. In response to the controller determining the current tilt exceeds the preset tilt threshold, the controller is configured to signal the braking controller to activate the braking system of the vehicle.

The vehicle can be an articulated dump truck. The current tilt can be a current lateral tilt. The tilt detector can be further configured to detect a current vertical tilt and the tilt controller can be configured to determine if the current vertical tilt exceeds a preset vertical tilt threshold. The tilt controller can be further configured to signal the braking controller to activate the braking system in response to the current vertical tilt exceeding the preset vertical tilt threshold.

The system can include a fluid driven piston configured to raise a cargo body. A fluid release valve can be in fluid communication with the piston and the current tilt can be a current lateral tilt. A second tilt detector can be located at the cargo body and the second tilt detector can be configured to detect a second current lateral tilt. The second tilt detector can be in communication with a second tilt controller. Alternatively, the second tilt detector can communicate with the tilt controller. The second tilt controller, or the tilt controller if the second tilt detector is placed in electronic communication therewith, can be configured to send an activation signal to an actuator of the fluid release valve in response to the respective controller determining that the second current lateral tilt exceeds a second preset tilt threshold.

The tilt controller can be placed in electronic communication with a drive controller of the vehicle and the tilt controller can be configured to determine if the vehicle is in a forward gear. The tilt controller can be configured to abstain from signaling the braking controller to activate in response to the vehicle being placed in a forward gear.

At least one of the tilt controller and tilt detector can be connected to a power source which only provides power when the vehicle is placed in a reverse gear. The tilt detector can be an inclinometer. The preset tilt threshold can be an angle selected from the range of 1 to 3 degrees of tilt and the vertical tilt threshold can be an angle selected from the range of 12 to 35 degrees of tilt.

A cargo body position sensor can be configured to detect if the cargo body is in a lowered position.

Other embodiments of the present application include unique tip-over prevention apparatuses, systems, and methods.

### BRIEF DESCRIPTION OF THE DRAWINGS

The description herein makes reference to the accompanying drawings wherein like reference numerals refer to like parts throughout the several views, and wherein:

FIG. 1 depicts a schematic view of an exemplary system for the detection of and response to lateral tilt in a dump trailer;

FIG. 2 is a schematic view of the level detector shown on a trailer in the lowest or travel position;

FIG. 3 is a schematic view of the level detector shown on a trailer in the raised position;

FIG. 4 is a schematic view of a bypass valve in a closed position;

FIG. 5 is a schematic view of the bypass valve in an open position;

FIG. 6 depicts one form of a tip-over prevention system for a dump trailer;

FIG. 7 depicts a schematic view of exemplary circuitry connections for a tip-over prevention system of the present invention, depicted as being affixed to a mixer vehicle;

FIG. 7A is a rear view of a mixer vehicle embodying the tip-over prevention system of FIG. 7A;

FIG. 7B is an enlarged view of tilt detector 704 of FIG. 7A;

FIG. 7C is a front view of a mixer truck embodying the system of FIG. 7A;

FIG. 7D is an enlarged view of tilt detector 708 of FIG. 7A;

FIG. 7E is a side view of the mixer truck embodying the system of FIG. 7A;

FIG. 8 depicts one form of a dual port piston, depicted as being powered by two fluid pumps;

FIG. 9 depicts yet another form of a tip-over prevention system, which is attached to an articulated dump truck;

FIG. 10 depicts a rear view of the articulated dump truck of FIG. 9, with the tip-over prevention system located thereon;

FIG. 11 depicts a schematic view of the components of the tip-over prevention system of FIG. 9;

FIG. 12A depicts an exemplary tip-over alert system according to another form of the present application, the system being depicted as affixed to a bus; and

FIG. 12B depicts a schematic view of the tip-over alert system of FIG. 12A.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated device, and any further applications of the principles of the invention as illustrated therein being contemplated as would normally occur to one skilled in the art to which the invention relates.

As utilized herein, the term “load carrying vehicle” includes any land traversing vehicle having a cargo body configured to haul a load, such as goods, liquids, minerals, soil, concrete, people, or any other load to be transported.

The term “cargo body” includes beds, mixer barrels, tanks (e.g., water and fuel tanker trucks, sewage pump trucks, etc.), and any other cargo.

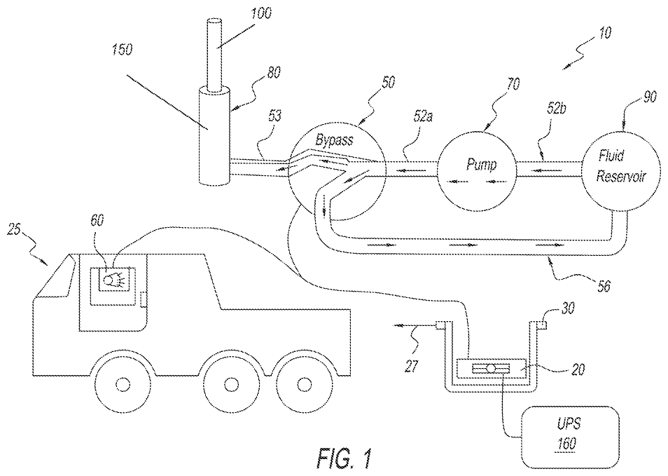

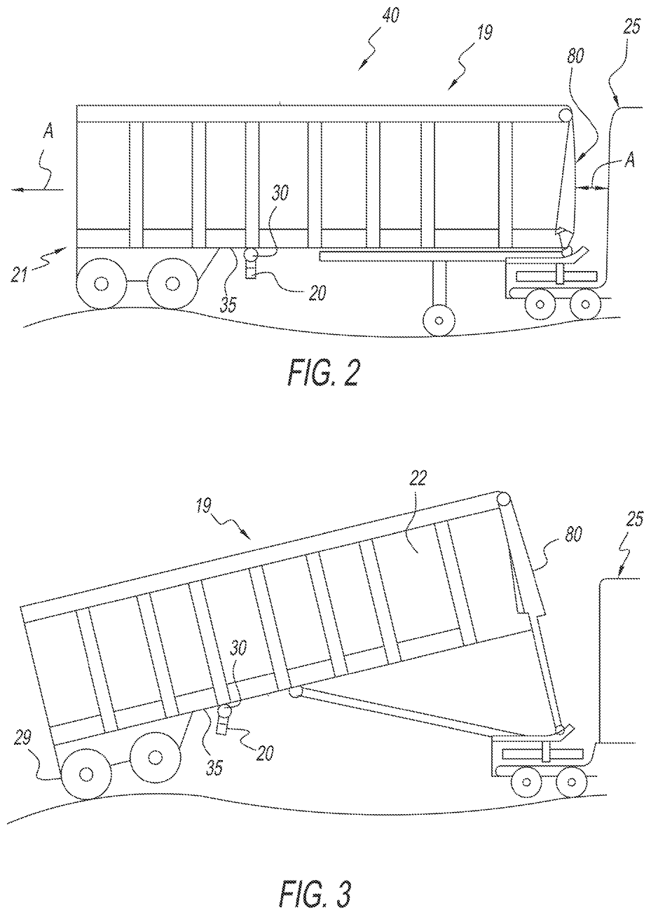

The term “dumping vehicle” includes dump trailers, dump trucks, and any other vehicles which include a bed or body portion (e.g., a cargo body) which is configured to tilt by elevating one end or side during offloading (“dumping”) the cargo. Although the term dump trailer is utilized in the following discussion with regard to FIGS. 1-6, the present application has equal applicability to various other dumping vehicles.

FIGS. 1- 3 present an illustrated overview of a typical embodiment of a system 10 for the detection of, and response to, lateral tilt in a dump trailer 40 that is coupled to a tow vehicle 25, such as a semi-tractor. The system 10 typically includes a tilt sensor 20. It is contemplated that the tilt sensor 20 can take a variety of forms including a slope detector, inclinometer, tilt box, or any other sensor/sensor array which can detect tilt, or through which tilt can be indirectly calculated. As illustrated in FIGS. 1-3, the tilt sensor 20 takes the form of a threshold angle detector (TAD) 20, which is a type of an inclinometer.

Tilt sensor 20 is depicted as being affixed to a longitudinal swing hinge 30 that pivots about a laterally extending axis, so that the TAD 20 can remain level (front-to-rear) independent the raised height of the dump bed 19. However, it is further contemplated that the TAD 20 can be mounted to a variety of locations on the dump bed 19, body 22, or chassis 21. It has been discovered that mounting the TAD 20 to the dumping bed 19 or chassis 21 can detect unsafe tilt prior to the axle being lifted from the ground (e.g., if an unbalanced load is raised in the cargo body 40, it has been discovered that tilt can be detected in the dumping bed 19 or chassis 21 prior to tilt being detected in the axle). As illustrated, the swing hinge 30 is affixed to the bottom of the dump trailer 40. In one specific form, the TAD 20 is mounted to a rear cross member (not shown) of the chassis 21.

The TAD 20 is operationally connected to a hydraulic bypass valve 50 and can be operationally connected to a warning buzzer 60. The hydraulic bypass valve 50 and warning buzzer 60 can receive control signals from the TAD 20, either directly or through a controller (not shown) which can control the positioning of the hydraulic bypass valve 50 and activation of the warning buzzer 60.

Hydraulic fluid from the fluid reservoir 90 passes through fluid line 52b toward the hydraulic pump 70 which acts upon the hydraulic fluid and discharges the hydraulic fluid into fluid line 52a. As is known to a person of skill, hydraulic bypass valves 50 are commonly utilized to control the raising and lowering of the hydraulic piston 80; therefore, controlling the raising and lowering of the dump bed 19. The hydraulic bypass valve 50 is depicted as being positioned in the fluid line 52a, downstream of the hydraulic pump 70. The hydraulic bypass valve 50 controls the flow of hydraulic fluid to the hydraulic piston 80. The bypass valve 50 can control the flow of fluid to the piston 80 by selectively blocking a return fluid line 56, which extends between an upstream end at bypass valve 50 and a downstream end at fluid reservoir 90.

As illustrated in FIG. 1, the lateral tilt detection device 20 is operationally connected to a warning device 60 and operationally connected to a hydraulic bypass device 50. The hydraulic bypass valve 50, when activated, presents an alternative flow for hydraulic fluid to return to the hydraulic reservoir 90 through return hose instead of being used to provide power to elevate a hydraulic piston 80.

As best shown in FIGS. 1-3, the system 10 for the detection of and response to lateral tilt in a dump trailer typically includes a lateral tilt detector device 20, which in one form preferably comprises a threshold angle detector (TAD) 20. The TAD 20 can be attached to the bottom of the bed or underside of the dump trailer 40 via a swing hinge 30 that pivots about an axis 27, generally perpendicular to the longitudinal axis A of the trailer. Pivot axis 27 is also generally (but usually not perfectly) parallel to the dumping pivot axis of the trailer, which, for the Applicant's trailers comprises the line along which the rear most set of tires 29 of the trailer 40 engage the ground surface. The free pivotal movement of the swing hinge 30 about axis 27 isolates the TAD 20 from the effects of the elevation of the bed 19 of trailer 40 during dump operations. Attaching the TAD 20 to the bottom support rail 35 of the bed 19 or underside of the dump trailer 40 permits accurate lateral tilt detection of the dump bed 19.

There are numerous other possible implementations of the lateral tilt detector device 20. For example, the TAD 20 can be a user adjusted variable TAD 20. The TAD 20 can take the form of a two-axis tilt detector that can be either user variable or fixed and can be used in combination with a variable response unit. Additionally, one could use weight distribution sensors (not shown) in combination one or more single or two axis tilt detectors that are either, user variable or fixed, with a variable response unit; and the like. It is important to note that the variable response unit of the examples is variable in the sense that varying conditions may be employed as the trigger point which activates the warning device 60 and actuation of the bypass valve 50 resulting in the piston 80 lowering. In this form, a user can be permitted to input the tilt angle at which the system will trigger the warning device 60 and actuate the bypass valve 50.

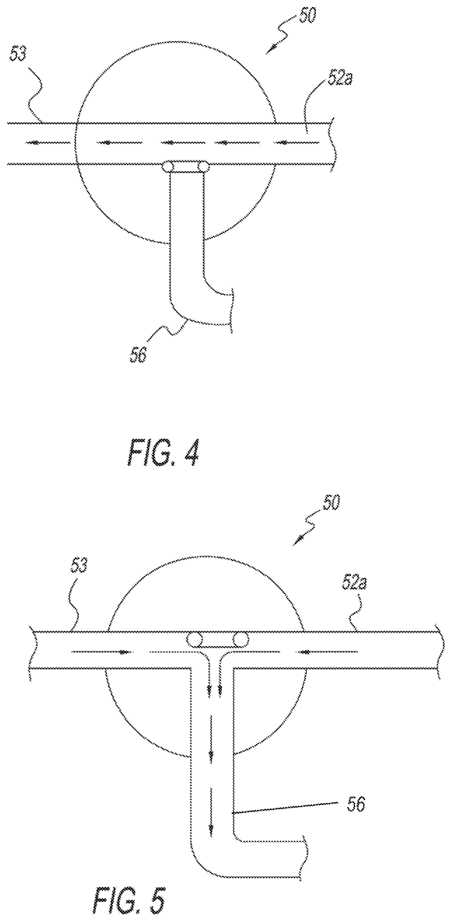

As is depicted in FIG. 1, the TAD 20 is operationally connected to a hydraulic bypass valve 50. To raise the dump trailer 40, the hydraulic bypass valve 50 is moved to the closed position, which is depicted in FIG. 4. In this closed position, the bypass valve 50 is positioned so that the return fluid line 56 is blocked and fluid flowing from the fluid reservoir 90 is pumped through the outflow tube 53 and into the hydraulic piston 80. As the hydraulic fluid is pumped into the hydraulic piston 80, the piston rod 100 is pushed outwardly from the hydraulic cylinder 150. For many dumping vehicles, such as dump trailer 40, this closed position is the default operating position for the bypass valve 50.

FIG. 5 depicts the bypass valve 50 in an open position. In this open position, the bypass valve 50 permits fluid to flow into fluid return line 56 (e.g., the bypass valve 50 no longer blocks the hydraulic fluid from passing into the fluid return line 56). When in the open position, the hydraulic fluid from the hydraulic piston 80 can flow through the outflow tube 53 (e.g., the direction of flow being reversed relative that shown in FIG. 4), down the return tube 56 and into the fluid reservoir 90. As is illustrated in FIG. 5, when in the open position, the bypass valve 50 directs the fluid flow from both the pump 70 and the hydraulic piston 80 to the return tube and into the fluid reservoir 90 to be recirculated by the pump 70.

When the TAD 20 detects a tilt angle which exceeds a preset angle (e.g., a “tilt condition”), a controller the hydraulic bypass valve 50 is opened. With the weight of the dump bed 19 pressing down upon the hydraulic rod 100, the hydraulic fluid in the cylinder 150 flows out of the cylinder 150, through the outflow tube 53, and into the return line 56. As is known to a person of skill, the lowering of the bed 19 under a tilt condition is not uncontrolled. Rather, the flow rate of fluid discharging from the hydraulic piston 80 is sufficient to allow the hydraulic rod 100 to descend into the cylinder 150, but the flow rate is not great enough to permit the bed 19 to descend at an uncontrolled rate.

The opening of the hydraulic bypass valve 50 and the corresponding lowering of the dump bed 19 can occur absent user intervention. This is because the TAD 20, or controller (not shown) receiving an output signal from the TAD 20, signals the hydraulic bypass valve 50 to open upon a tilt condition rather than merely warning a user. Additionally, the preferred “lower bed when tilt condition detected” protocol correctly responds to a dynamic or situationally induced tilt. This is because the TAD 20, or controller, signals the hydraulic bypass valve 50 to open only when it detects a dangerous tilt. It does not signal the hydraulic bypass valve 50 to open under other conditions.

It has been found by the Applicant that for many applications, the threshold value for a tilt condition can be between about 1 and 3 degrees of lateral tilt; therefore, the TAD 20 and/or controller can be set to signal the hydraulic bypass valve 50 to open when the TAD 20 detects a lateral tilt between 1 and 3 degrees. In one non-limiting form, the TAD 20 or controller can be programmed to signal the bypass valve 50 to open when the TAD 20 detects approximately 2 degrees of lateral tilt. If a lateral tilt of the set value (e.g., 2 degrees or greater) is sensed and/or determined by the TAD 20, the “lower bed when tilt condition detected protocol” is initiated and the bed is lowered.

However, it is contemplated that a variety of lateral tilt angles can be utilized depending upon the specific type of load the dumping vehicle will be utilized to haul, the typical load distribution within the dump bed 19, as well as the design parameters of the dumping vehicle, which can include but are not limited to the vehicle wheelbase, length of the dump bed 19, and maximum height the bed can be lifted. Preferably, the TAD 20 and/or controller signals a tilt condition prior to a wheel of the vehicle being lifted from the ground, thereby substantially reducing the likelihood that a tip-over will occur.

The TAD 20 can be operationally connected to a user warning device 60 located in the tractor 25 cab. The warning device 60 receives a signal from the TAD 20 during the existence of a tilt condition to warn the driver. The warning device 60 can take a number of forms, which include: a warning buzzer; warning bells; warning lights; warning lights in conjunction with audio warnings; gauges; and other driver warning devices. The warning device 60 is not active when there is no tilt condition or when a tilt condition has ended.

The warning buzzer 60 can be initiated anytime a tilt condition is detected by TAD 20, even if the bed is in a fully lowered position. An actuation of the warning buzzer 60 prior to raising the bed 19 can be used by the driver as a check to determine if his vehicle is at a suitable dumping location. Additionally, the detection by the TAD 20 of a tilt condition will automatically actuate the warning buzzer 60 anytime the driver signals the bed 19 to raise, thereby preventing the bed 19 from raising into a dump configuration.

The warning device 60 can be located on the dumping trailer 40 in a position that the driver can hear or see when the driver is seated in the cab. Locating the warning device 60 on the dumping trailer 40 does not require the cab of the tractor 25 to be retrofitted with the warning light 60 or buzzer which can be preferable for situations where specific tractors 25 and the trailers 40 to which they are attached are changed (e.g., a specific tractor 25 can pull different trailers 40). Alternatively, the warning device 60 can be wirelessly connected to the controller or TAD 20 and can be battery powered to permit ease of movement between tractors 25.

The warning buzzer 60 can give an audible signal in the event that tampering with the system 10 is detected. For example, the warning device 60 can be activated when the power 160, lateral tilt detection device 20, and/or hydraulic bypass valve 50 have been tampered with.

The system 10 can be powered by an uninterruptible power source (UPS) 160. One such suitable power source is the anti-lock brake system (ABS) of the dump trailer 40 as the ABS system is in an “always on” state when the truck 25 to which the trailer 40 is attached is running. It is also believed that the ABS of the dump trailer 40 is such a critical system that it will deter anyone from tampering with the ABS in order to disable the system 10.

There are numerous alternatives to using the ABS to power the system 10. The system 10 could be powered directly from the electrical power supplied to the hydraulic pump 70, from electrical power supplied to the dump trailer 40 light system, from the towing vehicle's 25 battery charging system, the towing vehicle's 25 battery system, and any other suitable power source.

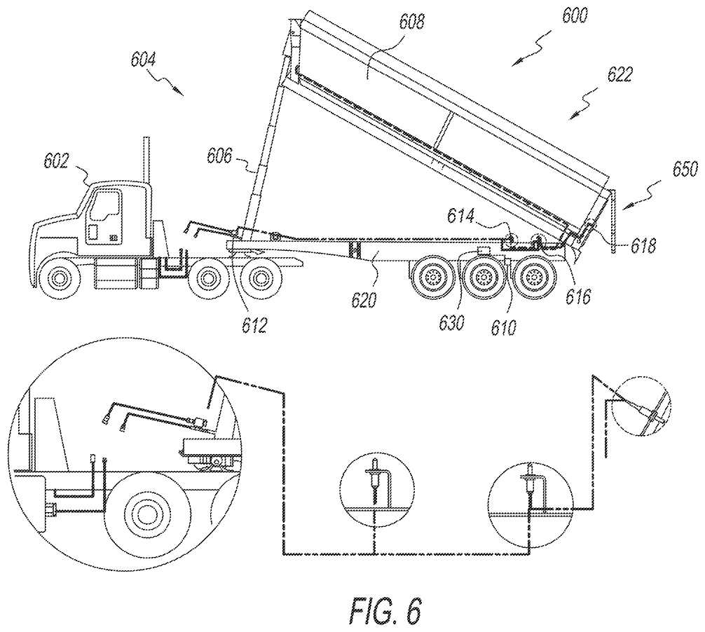

FIG. 6 depicts one form of tip-over prevention system 600 for dumping vehicles. A dump trailer 604 is depicted as being pulled by a tractor cab 602. A dump bed 608 can be raised and lowered from the trailer chassis 620 through a fluid powered piston 606. Although the piston 606 is depicted as a hydraulic piston, a pneumatic piston, or any other fluid powered piston 606 is contemplated herein. A fluid release valve 612 is in fluid communication with the fluid powered piston 606. When activated, the fluid release valve 612 releases fluid from the piston 606 thereby allowing the piston 606 to retract, and the dump bed 608 to lower from a raised position (depicted at 622) to a lowered position where a portion of the dump bed 608 rests on the trailer chassis 620.

A tilt detector 610 detects a current lateral tilt. This lateral tilt is the tilt to the left or right of the dump trailer 604, not the degree to which the bed 608 is raised. It is contemplated that the tilt detector 610 can take the form of an inclinometer, slope detector, tilt sensor, or any other device known to a person of skill which can detect tilt, or through which tilt can be determined. In one exemplary form, the tilt detector 610 can be a TAD as was discussed with regard to FIGS. 1-3. In a further exemplary form, the tilt detector 610 is able to detect tilt without any moving components. Tilt detectors 610 are available from a variety of sources, such as ACEINNA, Inc. of One Tech Drive, Suite 325, Andover, Mass., 01810. See www.ACEINNA.com. The lack of moving components in this exemplary tilt detector 610 has been discovered to be especially beneficial as debris cannot “clog” the components. Although the tilt detector 610 is depicted as being mounted on a rearward cross-member of a frame of the trailer 604 (e.g., which is a part of the chassis 620), it is contemplated that the tilt detector 610 can be mounted in a variety of locations on the dump bed 608 or trailer chassis 620.

The tilt detector 610 is in electronic communication with a tip-over prevention controller 630. The tip-over prevention controller 630 can form a portion of a processing subsystem including one or more computing devices having memory, processing, and communication hardware. The tip-over prevention controller 630 may be a single device or a distributed device, and the functions of the controller may be performed by hardware or software. In one form, the tip-over prevention controller 630 can be disposed within a tilt box enclosure which also houses the tilt detector 610.

The tip-over prevention controller 630 can be placed in electronic communication with the fluid release valve 612 and can activate and deactivate the fluid release valve 612. The tip-over prevention controller 630 receives the current tilt status from the tilt detector 610. The current tilt status can be communicated to the controller 630 from the tilt detector 610 in a variety of ways as would be understood to a person of skill.

The tip-over prevention controller 630 determines if the current tilt detected by the tilt detector 610 exceeds a tilt threshold. If the current tilt exceeds the tilt threshold, the tip-over prevention controller 630 will activate the fluid release valve 612, thereby causing the release of fluid from the piston 606. This results in the dump bed 608 being lowered from the raised position 622 to a lowered position where a portion of the dump bed 608 rests on the chassis 620. This automatic lowering of the dump bed 608 has been found to significantly reduce tip-overs due to operator error by automatically lowering dump bed 608 in the event the operator attempts to raise the bed 608 on an unsafe incline (e.g., due to soft ground, uneven ground, an unbalanced load, or the like). As the dump bed 608 lowers, so does the center of gravity, thereby significantly reducing the likelihood of a tip-over.

The tilt threshold is a preset value which determines at which level of tilt the dump bed 608 will be automatically lowered by the tip-over prevention controller 630. In one form, the tilt threshold can be programmed into the tip-over prevention controller 630 in a manner such that the value cannot be altered by a driver or operator. The specific tilt threshold value can be chosen depending upon the specific user and/or the specific application. For example, a trucking company which has many novice drivers may want a lower tilt threshold than a trucking company with expert drivers who frequently dump gravel on uneven terrain. In various applications, the tilt threshold can be preset to a value which ranges from just below the tilt value at which the dump trailer 604 will tip-over (on the high end) to one degree off level (on the lower end). As a non-limiting example, the tilt threshold can be set between 1 and 3 degrees off-level.

In one exemplary form, a bed position sensor 614 is placed in electronic communication with the controller 630. The bed position sensor 614 is depicted as a contact sensor which detects contact between the dump bed 608 and the chassis 620 which can be utilized to detect and/or determine if the dump bed 608 is lowered onto the chassis 620 or is raised therefrom. However, it is contemplated that a variety of bed position sensors 614 can be utilized to determine the position of the dump bed 608. When the current tilt exceeds the tilt threshold, the controller 630 may signal the fluid release valve 612 to release fluid from the piston 606 until the bed position sensor 614 indicates the dump bed 608 is in a lowered position.

In a further form, a tailgate position sensor 618 can be located on the bed 608 in a manner sufficient to determine a position of the tailgate 650 (e.g., open or closed). This tailgate position sensor 618 has been determined to be of significant benefit for some applications. The tailgate position sensor 618 is placed in electronic communication with the controller 630. The controller 630 will not permit the bed 608 to be raised if the tailgate position sensor 618 determines the tailgate 650 is in a closed position. Additionally and/or alternatively, if the controller 630 detects the bed 608 is in a raised position 622 and the tailgate 650 is in a closed position, the controller 630 will activate the fluid release valve 612 thereby lowering the bed 608. In this manner, the present system 600 can prevent tip-overs due to an operator forgetting to remove the safety locks on a tailgate prior to raising the bed 608.

Mining operations in various countries utilize sealed trailer covers to prevent theft of the minerals (e.g., gold, silver, zinc, etc.) as the minerals are hauled from the mines. These sealed trailer covers may utilize locks similar to those on shipping containers (e.g., a lock that has to be cut off once installed and is therefore tamper evident). When these materials arrive to the place of delivery, an inspector inspects these locks and removes them. However, because this material is often powder, the tailgates have turn buckle security locks that retain the tailgate 650 tight to prevent leaking of the materials. Often, drivers forget to unscrew these turn buckles prior to raising the bed 608 to unload. This failure to open the tailgate 650 prevents the load from sliding out and can cause the bed 608 to tip-over side-ways and/or break the hoist in the front resulting in a totaled trailer.

A further form of a tailgate position sensor 618 will now be described. The tailgate position sensor 618 can be a push button switch located between the tailgate 650 and a rear post of the trailer. Such posts are frequently utilized to help support the shape of the body of the dump bed 608. When the tailgate 650 is closed, the switch 618 is compressed allowing electric current (12 or 24 volts) to pass through the switch 618 to the bed position sensor 614, which can also be a push button type switch. The bed position sensor 614 can be located between the trailer chassis or A-frame and the bed 608. This switch, when in a compressed position, does not allow current to pass through to the fluid release valve 612.

With the tailgate 650 closed, the tailgate position sensor 618 permits current to flow through the sensor 618 to the bed position sensor 614. When the dump bed 608 contacts against the bed position sensor 614, the bed position sensor 614 prevents current from being transferred to the fluid release valve 612. However, if the bed 608 is raised with the tailgate 650 closed, the tailgate position sensor 614 will permit current to flow to the bed position sensor 614 and the bed position sensor 614 will permit current to flow to the fluid release valve 612, thereby preventing the dump bed 608 from being raised without the tailgate 650 opening. In this manner, the system 600 can prevent the driver from raising the bed 608 unless the tailgate 650 opens shortly after the bed 608 is lifted off from the bed position sensor 614. When the tailgate 650 swings open, the tailgate position sensor 614 prevents current from flowing to the bed position sensor 614, and therefore prevents current from flowing to the fluid release valve 612, which permits the dump bed 608 to be raised.

In various forms, the system 600 can be easily retrofitted into preexisting dumping vehicles. To achieve this, the system 600 can be packaged as a kit which includes a tilt box housing the tilt detector 610 and the controller 630. The kit can include plug and play harnesses, or wire, to connect the controller 630 and other system components such as the fluid release valve 612. The kit further includes the fluid release valve 612 as well as a valve cartridge, coil, and valve body. In one specific form, the valve cartridge is a 40-GPM 5000 PSI valve cartridge, and the valve body is a 2-way valve body; however, a variety of fluid release valves 612 are contemplated herein. The kit can include plumbing, including fittings, to fluidly connect the fluid release valve 612 to the piston 606. In one specific form, the tilt detector 610 and controller 630 receive power from the ABS system of the dumping vehicle 602.

As was described with FIGS. 1-3, an alarm can be activated when the current tilt exceeds the threshold tilt limit. This alarm can be an audible alarm, a light, or any other alarm type suitable to make a user aware of this alarm condition.

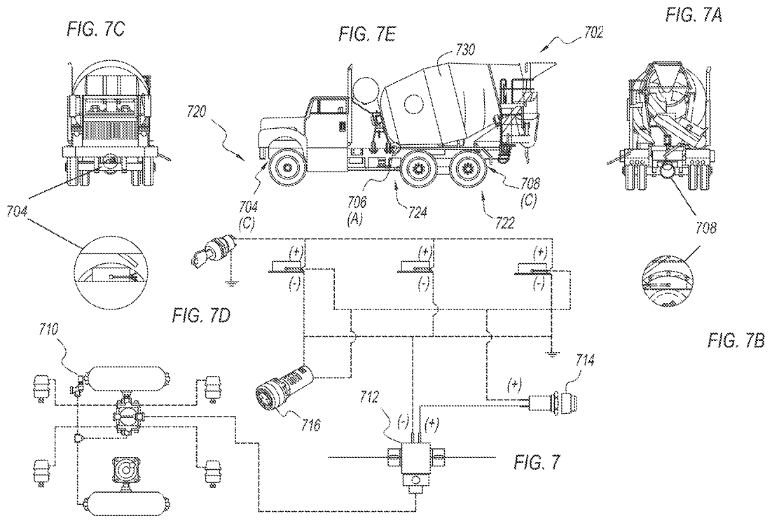

FIG. 7 depicts one form of a mixer vehicle tip-over prevention system. A mixer vehicle 702 is depicted as a concrete mixer; however, a variety of mixer vehicles are contemplated herein. A first tilt detector 704 can be mounted to the foremost axle 720. A second tilt detector 708 can be mounted on the rearmost axle 722. A third tilt detector 706 can be mounted on the truck chassis 724 below the mixer barrel 730. The tilt detectors 704, 706, and 708 can take a variety of forms similar to tilt detector 610 from FIG. 6.

The tilt detectors 704, 706, 708 can be integrated with one or more controllers as was discussed with controller 630 of FIG. 6. Should a current detected tilt of one or more of the first tilt detector 704, second tilt detector 708, or third tilt detector 706 exceed a preset tilt limit, a braking system 710 of the mixer vehicle 702 is activated. Depending upon the specific application and desired safety parameters, the braking system 710 may be activated in response to one, two, or all three of the tilt detectors 704, 706, 708 determining a present tilt exceeds a threshold tilt limit. In a preferred form, the braking system 710 is activated in response to any of the tilt detectors 704, 706, 708 determining a present tilt exceeds the threshold tilt limit. In one form, activating the braking system 710 includes engaging the parking brakes of the mixer vehicle 702 via a solenoid 712 integrated into the parking and/or emergency brake.

As was described with FIGS. 1-3, an alarm can be activated when the current tilt exceeds the threshold tilt limit. This alarm can be an audible alarm, a light, or any other alarm type suitable to make a user aware of this alarm condition.

An override button 714 is depicted as being electrically connected to the braking system 710 (e.g., either directly, or indirectly via one or more controllers). When the braking system 710 has been engaged, a driver can depress the override button 714 and, while continually depressing the override button 714, may reverse the vehicle out of the unsafe tilt condition. However, should the vehicle be placed in a forward gear, the system 710 will again engage the braking system 710. When the vehicle is to a safe location, e.g., when the tilt detectors 704, 706, and 708 signal a current tilt is less than a preset tilt limit, the alarm will stop sounding, the driver may remove their hand from the override button 714 and can proceed to drive the vehicle as normal.

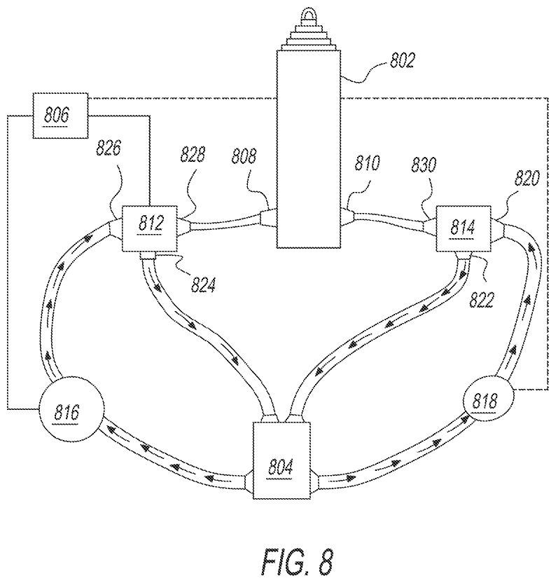

Referring now to FIG. 8, an exemplary dual port piston 802 will be described. This piston 802 is depicted as including two ports, including first fluid release port 808 and second fluid release port 810. The first fluid release port 808 is in fluid communication with first release valve 812, and the second fluid release port 810 is in fluid communication with the second release valve 814.

To increase the speed at which the dumping bed of a vehicle can be lowered, or raised, it has been discovered that both ports 810, 808 can be utilized. As is illustrated, a fluid reservoir is depicted at 804. Fluid from this reservoir is drawn into first 816, and second 818 pumps. This exemplary system includes two fluid pumps 816, 818. In a preferred form, both fluid pumps 816, 818 are driven through a Power Take Off, commonly referred to as a PTO, of the transmission of the vehicle to which the dumping bed is attached.

Once the fluid has been acted on, and pressurized by, the pumps 816, 818, the fluids travel to release valve 812, 814. Release valve 812 is depicted as having an inlet 826 which receives pressurized fluid from the pump 816, a first outlet 824 which directs fluid toward the reservoir 804, and a second outlet 828 which directs the pressurized fluid toward the piston 802. Release valve 814 is similarly depicted as including inlet 820, reservoir outlet 822, and piston outlet 830. As was previously described, these release valves 812, 814 can be two-way valves. The release valves 812, 814 control whether the fluid from the pumps 816, 818 are directed toward the piston 802 resulting in the extension of the piston 802, or back toward the fluid reservoir 804. When the release valves 812, 814 are activated, the fluid within the piston 802 is permitted to leave the piston 802, to the release valves 812, 814, and to the reservoir 804. As the fluid leaves the piston, the pressure within the piston 802 reduces, and the piston retracts. Such action would result in the bed of a vehicle lowering, as was discussed with regard to FIGS. 1-3.

As is illustrated, a controller 806 is placed in electronic communication with the each of the pumps 816, 818, as well as each of the release valves 812, 814. In this manner, the controller can be utilized to control the pumps 816, 818, as well as the release valves 812, 814 in response to various sensor inputs e.g., a tilt sensor, bed position sensor, tailgate position sensor, as were previously described.

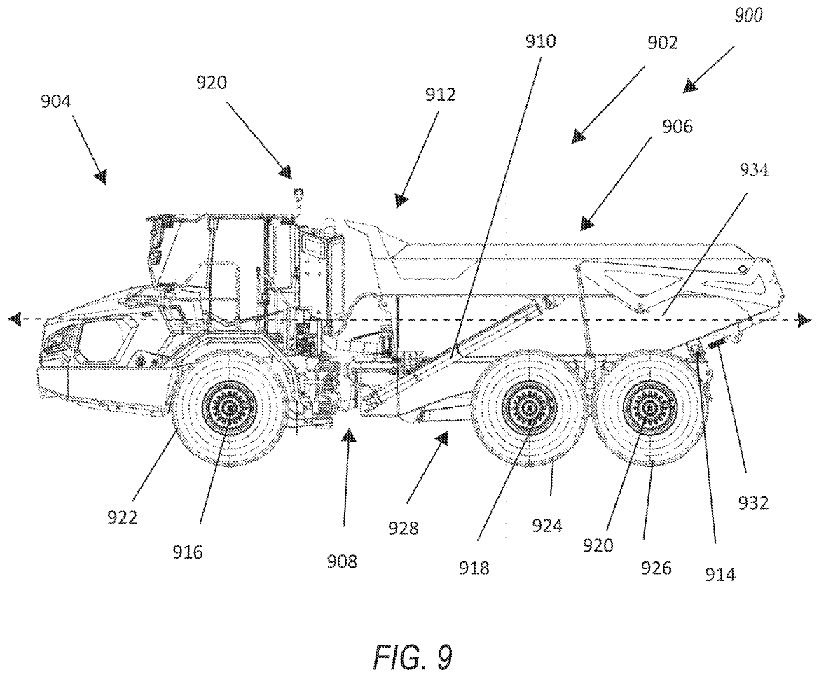

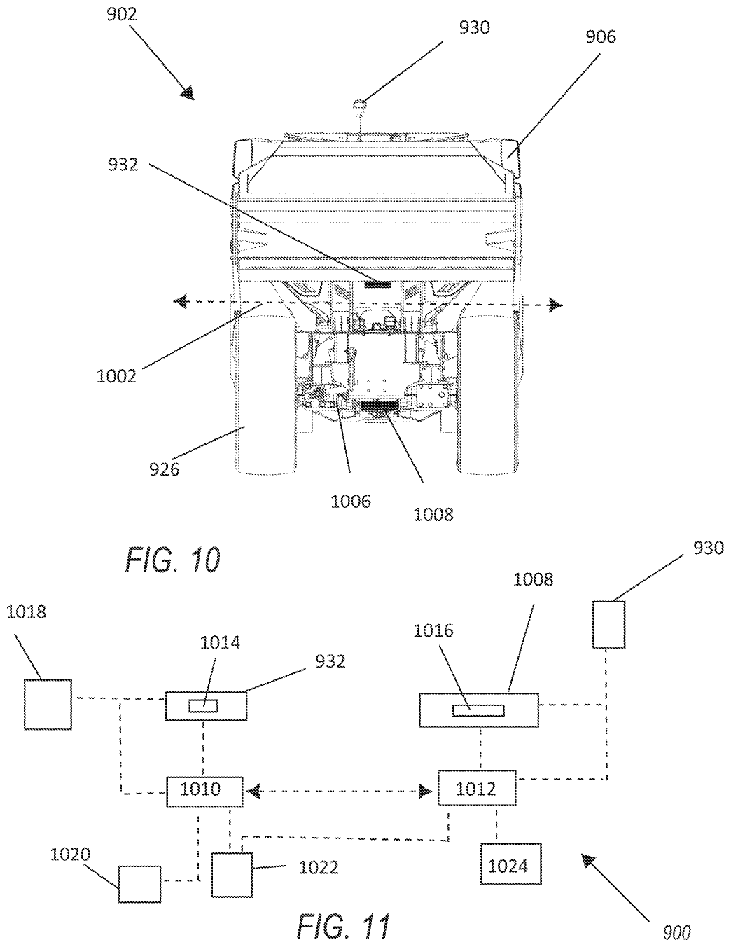

Referring now to FIGS. 9-11 another form of a tip-over prevention system 900 will now be described. The tip-over prevention system 900 is depicted as being mounted to an articulated dump truck 902 (hereinafter “ADT 902”). As is known, ADT 902 is a dumping vehicle which has a cab 904 and a cargo body 906. The cargo body 906 is coupled with the cab 904 through an articulating joint 908. This articulating joint 908 enables the cargo body 906 to move independently, from side to side, relative the cab 904. The articulating joint 908 enables the ADT 902 to traverse very rough terrain and provides the ADT 902 with a tight turning radius. Additionally, should the cargo body 906 tip-over, the articulating joint 908 can enable the cab 904 to remain upright.

The cargo body 906 is depicted as a dump bed 906. The dump bed 906 is pivotably coupled to a chassis 928 of the ADT 902 at a pivot 914. A fluid driven piston 910 is attached between the dump bed 906 and the chassis 928 so that the piston 910 can raise (when extended) and lower (when retracted) a front 912 of the dump bed 906. As the piston 910 extends upwardly, the dump bed pivots on pivot 914 and the front 912 of the dump bed 906 raises.

The ADT 902 is depicted as having three axles, with axle hubs depicted at 916, 918, 920. The ADT 902 is depicted as taking a 6×6 configuration (e.g., with six drive wheels, with the three left side wheels depicted as 922, 924, and 926). However, it is contemplated that the tip-over prevention system 900 can be affixed with a variety of vehicles to prevent tip-overs, and these vehicles can have a variety of wheel/drive wheel configurations.

Brakes (not shown) are functionally coupled with one or more of the axles near the axle hubs 916, 918, and 920. The braking system (not shown) of the ADT 902 can include a brake controller 1024 which controls the brakes of the ADT 902. An emergency braking system (not shown) is typically present on ADT 902.

The tip over prevention system 900 is configured to detect and/or determine a current tilt of the chassis 928, the current tilt of the cargo body 906, and/or the current tilt of the cab 904. Should the system 900 determine the current tilt exceeds a safe tilt, the system 900 can communicate to various on-board systems which are integrated into the ADT 902 to signal those systems to take actions in order reduce the likelihood of a tip-over.

The tip over prevention system 900 includes a first tilt detector 1008. The tilt detector 1008 can take a number of forms as were previously discussed herein (e.g., tilt detector 1008 can take the forms of TAD 20, the forms of tilt detector 610, etc.). In a preferred form, the tilt detector 1008 takes the form of a two-axis tilt detector 1008. A two-axis tilt detector 1008 can detect and/or sense the current lateral tilt (i.e., side to side tilt) and can detect and/or sense the current vertical tilt (i.e., up and down). The lateral tilt, or side to side tilt, can be viewed relative horizontally extending axis 1002. For example, a lateral tilt of 1 degree indicates the vehicle is at 1 degree relative the widthwise axis 1002. Vertical tilt can be viewed relative to axis 934. For example, a current vertical tilt of 10 degrees indicates the vehicle is at 10 degrees relative longitudinal axis 934.

The tilt detector 1008 can include a two-axis inclinometer 1016, or the tilt detector 1008 can include twin inclinometers with one inclinometer sensing the current lateral tilt and the other sensing the current vertical tilt. However, it is also contemplated that two separate single-axis tilt detectors 1008 can be utilized with equal effect (e.g., with one detecting the current lateral tilt and another detecting the current vertical tilt).

The tilt detector 1008 is depicted as being mounted to the chassis 928 of the ADT 902. The first tilt detector 1008 can be mounted to an axle housing 1006 of the ADT 902. The axle housing 1006 is depicted as the rearmost axle housing 1006 of the ADT 902. When the ADT 902 reverses, the wheels (e.g., the left side wheel depicted at 926) which are mounted to the rearmost axle hub 920 will be subjected to any tilt inducing obstacle first. Exemplary tilt inducing obstacles include, bumps or mounds, soft ground, and drop-offs as may be encountered at mine sites. It is believed that mounting the tilt detector 1008 to the rearmost axle housing 1006 can provide an early indication of an unsafe tilt condition, prior to a tip-over.

However, it is contemplated that the tilt detector 1008 can be mounted to a variety of locations on the chassis 928 of the ADT 902, such as the frame (not shown), a variety of chassis 928 and/or frame cross members, or the other axles of the ADT 902 (e.g., the hubs of which are depicted at 916 and 918), depending upon the specific application.

Referring now to FIG. 11, the tilt detector 1008 is in electronic communication with a tilt controller 1012. The tilt controller 1012 can form a portion of a processing subsystem including one or more computing devices having memory, processing, and communication hardware. The tilt controller 1012 may be a single device or a distributed device, and the functions of the tilt controller 1012 may be performed by hardware or software. The tilt detector 1008 can be integrated with the tilt controller 1012 and/or the tilt detector 1008 and tilt controller 1012 can be disposed in a tilt box, as was previously described.

The tilt controller 1012 receives or reads the current lateral tilt and the current vertical tilt from the tilt detector 1008. A lateral tilt threshold and a vertical tilt threshold can be pre-programmed into the tilt controller 1012 or can be read by the tilt controller 1012 (e.g., if the thresholds are output by the tilt detector 1008 itself).

The tilt controller 1012 compares the current lateral tilt with the lateral tilt threshold to determine if an unsafe tilt condition is present. If the current lateral tilt exceeds the preset lateral tilt threshold, the tilt controller 1012 determines that an unsafe tilt condition is present. The tilt controller 1012 compares the current vertical tilt with the preset vertical tilt threshold. Should the tilt controller determine that the current vertical tilt exceeds the preset vertical tilt threshold, the tilt controller 1012 determines an unsafe tilt condition is present.

The tilt controller 1012 is in electronic communication with the braking controller 1024 of the ADT 902. When the tilt controller 1012 determines that an unsafe tilt condition is present, with regard to either vertical tilt or lateral tilt, the tilt controller 1012 signals the braking controller 1024 of the ADT to activate the brakes, resulting in the brakes being engaged to stop the ADT 902. Alternatively, the tilt controller 1012 can signal the emergency braking system of the ADT 902 to activate in response to a determination of an unsafe tilt condition. In this manner, the tilt controller 1012 automatically activates the brakes of the ADT 902, without any operator intervention, in response to an unsafe tilt condition.

As has been described, the detection of an unsafe tilt condition with regard to lateral tilt can reduce side to side tip-overs. Solely viewing the current lateral tilt will not prevent an operator from backing off an incline or rock face (e.g., assuming the current lateral tilt does not exceed the lateral tilt threshold as would occur if the vehicle backing off the cliff is laterally level). Rather, such back off tip-overs can be prevented by the tilt controller 1012 comparing the current vertical tilt with the vertical tilt threshold and signaling the braking controller 1024 of the ADT 902 to activate in response to the current vertical tilt exceeding the vertical tilt threshold.

As has been described with regard to the tilt threshold of FIG. 6, the lateral tilt threshold value and vertical tilt threshold value can take a number of values, which can depend upon the specific application and the maximum tilt the vehicle 902 can tolerate prior to tip-over. As a non-limiting example, the lateral tilt threshold can be an angle in the range of 1 to 3 degrees and the vertical tilt threshold can be an angle in the range of 12 to 45 degrees. In a further non-limiting example, the lateral tilt threshold can be angle approximating 2 degrees and the vertical tilt threshold can be an angle in the range of 15 to 35 degrees. As will be appreciated by a person of skill, the lateral tilt threshold and the vertical tilt threshold should be low enough to prevent a tip-over of the ADT 902 but not so low as to prohibit the ADT 902 from being able to operate in rough terrain.

ADTs 902 are frequently utilized to traverse very harsh terrain; therefore, it may be desirable to limit activation of the brakes to those times when the ADT 902 is most likely to tip-over. The controller 1012 can be placed in electronic communication with a drive controller and/or reverse switch (not shown). The controller 1012 can be programmed to only signal the braking controller 1024 or emergency brakes to activate when the ADT 902 is placed in reverse.

Alternatively, the controller 1012 and/or the tilt detector 1008 may be wired so that they are only powered when the ADT 902 is placed in reverse. For example, the controller 1012 and/or the tilt detector may be wired with the reverse light 930 so that they are only powered on when the reverse light is on (e.g., when the ADT 902 is placed in reverse). It is also contemplated that the controller 1012 and/or the tilt detector may be wired with a reverse switch, a backup alarm, or other device which only receives power when the ADT 902 is placed in reverse.

In this “powered only in reverse configuration”, when the operator of the ADT 902 places the vehicle in a forward gear, the controller 1012 and/or the tilt detector 1008 will lose power. The controller 1012 will no longer send the signal to the braking controller 1024 to activate. Therefore, the brakes will return to their standard mode of “disengage”. The operator may then drive the ADT 902 to a safe tilt location (e.g., where the current lateral tilt and current vertical tilt are less than the lateral tilt threshold and the vertical tilt threshold) to continue their work and attempt to reach the desired location taking a different path.

It is also contemplated that the controller 1012 and/or the tilt detector 1008 can be powered from a variety of sources, such as with an uninterrupted power supply UPS 160. An override button (not shown) may be located inside the cab 904 of the ADT 902. The override button can be electronically connected to the tilt controller 1012 or directly to the braking controller 1024. When the braking controller 1024 has been activated in response to an unsafe tilt condition, an operator can depress and hold the override button. When the controller 1012 determines that the override button is being held in a depressed state, the tilt controller 1012 will cease sending the activate signal to the braking controller 102 and the operator can drive the ADT 902 forward out of the unsafe tilt condition. However, should the vehicle be placed in reverse, the tilt controller 1012 will again activate the braking controller 1024 preventing movement of the ADT 902, even if the operator is depressing the override button.

When the ADT 902 returns to a safe tilt location (e.g., when the tilt detector 1008 determines that the current lateral tilt is less than the programmed lateral tilt threshold and the current vertical tilt is less than the vertical tilt threshold), the operator may remove their hand from the override button and can proceed to drive the ADT 902 in a normal manner.

It is contemplated that system 900 components previously described can be sold as a kit for retrofit or new installation applications. However, it is also contemplated that the system 900 can additionally include a secondary anti-tip system that is configured to automatically lower the dump bed 906 in response to a tilt condition of the cargo body 906.

Referring back to FIGS. 9-11, a second tilt detector 932 is depicted as being mounted to the dump bed 906 toward the pivot 914. The tilt detector 932 is depicted as having an inclinometer 1014; however, the tilt detector 932 can take a variety of forms to detect a current lateral tilt of the dump bed 906, as have been described. A dump bed tilt controller 1010 electronically communicates with the tilt detector 932. The dump bed tilt controller 1010 and the tilt controller 1012 can be a single controller or can be separate controllers as shown in FIG. 11. The dump bed tilt controller 1010 is structured to compare the current lateral tilt of the dump bed 906, detected by the tilt detector 932, and to compare the current lateral tilt of the dump bed 906 with a preset dump bed 906 lateral tilt threshold. The dump bed 906 lateral tilt threshold can have the same value as the lateral tilt threshold as was discussed above.

In operation, a power supply 1018 powers the second tilt detector 932 and the dump bed tilt controller 1010. The power supply 1018 can provide power to the second tilt detector 932 and the dump bed tilt controller 1010 at all times that an ignition switch of the ADT 902 is in an on configuration. The dump bed tilt controller 1010 constantly reads the current lateral tilt detected by the tilt detector 932 and compares the current lateral tilt with the preset dump bed 906 lateral tilt threshold. In response to the dump bed tilt controller 1010 determining that the current lateral tilt exceeds the preset dump bed 906 lateral tilt threshold, the dump bed tilt controller 1010 signals an actuator 1020 of a bypass valve to open, which allows fluid to escape from the piston 910 and automatically lowers the dump bed 906 downwardly onto the chassis 928. The dump bed tilt controller 1010 can continue to signal the bypass valve to open until the controller 1010 determines that the current dump bed 906 lateral tilt is less than the predetermined dump bed 906 lateral tilt threshold.

As was described with regard to FIG. 6, the controller 1010 can additionally activate an alarm 1022 and can be programmed to receive inputs from a bed position sensor or a tailgate position sensor, if desired.

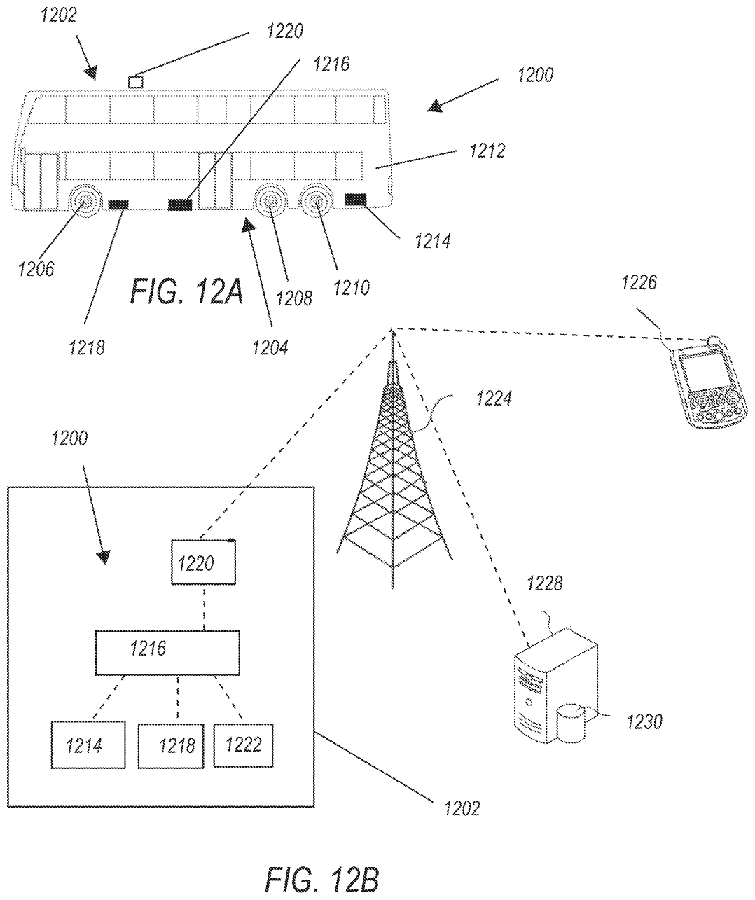

Referring now to FIG. 12A and 12B, an exemplary tip-over alert system 1200 will now be described. Although this system 1200 is depicted as being mounted on a double decker bus 1202, it is contemplated that the system 1200 can be utilized on a variety of load carrying vehicles. System 1200 is depicted as including a tilt detector 1214, a controller 1216, and a communication module 1220. The system 1200 can include a GPS module 1218 and a vehicle 1202 speed detection module 1222.

The tilt detector 1214 can take a number of forms, as has have been described herein. The tilt detector 1214 is depicted as being mounted at a body 1212 of the vehicle 1202. However, the tilt detector 1214 can be mounted to a chassis 1204 of the vehicle 1202, such as a frame of the vehicle 1202 or on axles 1206, 1208, and/or 1210. The tilt detector 1214 can be a multi-axis tilt detector. The tilt detector 1214 is configured to detect and/or sense at least one of a current lateral tilt.

The controller 1216, is depicted as being in electronic communication with the tilt detector 1214, the GPS module 1218, the communication module 1220, and the speed detection module 1222. The controller 1216 can take a variety of forms, as have been previously described. The controller 1216 is programmed with a warning tilt threshold and an emergency tilt threshold. The warning tilt threshold has a value less than the emergency tilt threshold.

The controller 1216 reads or receives the current tilt from the tilt detector 1214. The controller 1216 compares the current tilt with the warning tilt threshold and the emergency tilt threshold. In response to the controller 1216 determining that the current tilt exceeds the warning tilt threshold, but not the emergency tilt threshold, the controller 1216 signals a “warning tilt condition”. In response to the controller 1216 determining that the current tilt exceeds the emergency tilt threshold, the controller 1216 signals an “emergency tilt condition.”

Preferably, the warning tilt threshold is assigned a value that is less than the tilt necessary for a tip-over, while the emergency tilt threshold is assigned a value which is greater than the tilt required for a tip-over. In this manner, determining that the warning tilt threshold has been exceeded can be utilized to send a warning to the operator (e.g., use care, slow down, etc.). On the other hand, if the controller 1216 determines that the current tilt exceeds the emergency tilt threshold, the vehicle 1202 has had a tip-over. As a non-limiting example, the warning tilt threshold can be set in the range of 1 or 2 degrees with regard to lateral tilt and the emergency tilt threshold can be set in excess of 10 degrees with regard to lateral tilt.

The controller 1216, tilt detector 1214, GPS module 1218, and communication module 1220 are preferably powered by an uninterruptable power supply, such as described at 160. The communication module 1220 is configured to wirelessly communicate, such as through a cellular tower 1224 or via satellite. An antenna (not shown) can be electronically coupled with the communication module 120.

The GPS module 1218 can be a stand-alone GPS 1218 or can interact with the communication module 1220. The GPS module 1218 can utilize the signals received by the communication module 1220 to determine the coordinates of the GPS module 1218 via triangulation relative a number of cellular towers 1224 or satellites, as is known.

During operation of the system 1200, the controller 1216 reads or receives the current tilt from the tilt detector 1214 and compares the current tilt with the warning tilt threshold and with the emergency tilt threshold. In response to the controller 1216 determining that a current tilt exceeds the warning tilt threshold, the controller 1216 determines a “warning tilt condition” is present. When the controller 1216 determines a “warning tilt condition” is present, the controller 1216 signals the communication module 1220 to communicate that the vehicle 1202 is subject to a “warning tilt condition”. Preferably, this message can be transmitted to a third party, such as the safety department of the company employing the operator. For example, the “warning tilt condition” message can be transmitted to the phone 1226 of the safety department call center or to one or more computers 1228.

The controller 1216 can read the vehicle speed from the vehicle speed detection module 1222 and GPS coordinates from the GPS module 1218 and can communicate this information to the safety department via the communication module 1220. For example, an exemplary “warning tilt condition” message to the safety department can include: a vehicle identification number or operator name, the value of the current angle of tilt which exceeded the warning tilt threshold and/or a percentage by which the warning tilt threshold was exceeded, the speed of the vehicle taken at the time the angle of tilt exceeded the warning tilt threshold, and the location coordinates of the vehicle 1202. This information can additionally be logged in a database 1230 so that operator performance can be reviewed over time.

The controller 1216 may activate an alarm (not shown) to alert the operator that a “warning tilt condition” was determined and that the safety department was contacted.

Additionally, safety department personnel may contact the operator of the vehicle 1202 directly to tell the operator to slow down or to utilize caution.

In response to the controller 1216 determining that a current tilt exceeds the emergency tilt threshold, the controller 1216 determines an “emergency tilt condition” is present. When the controller 1216 determines an “emergency tilt condition” has occurred, the controller 1216 signals the communications module 1220 to communicate an “emergency tilt condition” message to emergency responders. As was described, the emergency tilt threshold is sufficiently high so that an emergency tilt condition will only occur when the vehicle 1202 has had a tip-over.

The “emergency tilt condition” message communicated by the communications module 1220 to the emergency responders can include the following information: the coordinates of the vehicle 1202, the speed of the vehicle at the time of the “emergency tilt condition”, the type of vehicle (e.g., whether vehicle 1202 is the type of vehicle to haul many passengers) and that the vehicle 1202 has turned over. The controller 1216 can be programmed to continue to send the coordinates of the vehicle 1202 every few minutes after the “emergency tilt condition” has occurred so that if the vehicle 1202 is sliding down a mountain, the emergency responders will be able to quickly proceed to the crash site of the vehicle 1202, not just to the section of road where the “emergency tilt condition” first began.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law.

Furthermore, it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A tip-over prevention method for a load carrying vehicle, comprising:
providing a load carrying vehicle having a chassis, a braking system, and a cargo body;
mounting a tilt detector to the chassis of the load carrying vehicle at a location below the cargo body;
detecting a current tilt at the chassis; and
activating the braking system of the load carrying vehicle in response to the current tilt exceeding a predetermined tilt threshold.

2. The method of claim 1, wherein mounting the tilt detector to the chassis further comprises attaching the tilt detector to an axle.

3. The method of claim 2, wherein the axle is a rearmost axle of the load carrying vehicle.

4. The method of claim 2, further comprising:
placing a controller in electronic communication with the tilt detector and the braking system, wherein the controller is configured to perform the following steps:
comparing the current tilt and the predetermined tilt threshold; and
providing an activate signal to the braking system in response to the current tilt exceeding the predetermined tilt threshold.

5. The method of claim 4, wherein providing a load carrying vehicle further comprises providing one of a mixer vehicle and a tanker truck.

6. The method of claim 5, further comprising:
mounting a second tilt detector to a forward axle of the load carrying vehicle, wherein the second tilt detector is configured to detect a second current tilt, wherein the current tilt is a current lateral tilt and wherein the second current tilt is a second lateral tilt; and
activating the braking system of the load carrying vehicle in response to the second current lateral tilt exceeding a predetermined second tilt threshold.

7. The method of claim 6, further comprising:
providing a user activated override within a cab of the load carrying vehicle; and
deactivating the braking system of the load carrying vehicle in response to the override being activated and in response to a transmission of the load carrying vehicle being placed in reverse.

8. The method of claim 4, wherein detecting the current tilt further comprises detecting a current lateral tilt and detecting a current vertical tilt, the method further comprising:
comparing the current lateral tilt to a predetermined lateral tilt threshold;
comparing the current vertical tilt to a predetermined vertical tilt threshold; and
activating the braking system of the load carrying vehicle in response at least one of the current lateral tilt exceeding the predetermined lateral tilt threshold and the current vertical tilt exceeding the predetermined vertical tilt threshold.

9. The method of claim 8, wherein providing the load carrying vehicle further comprises providing an articulated dump truck, wherein the articulated dump truck includes a piston configured to raise a portion of the cargo body, wherein a fluid release valve is operably coupled with the piston, and wherein the tilt detector is mounted to a rearmost axle of the articulated dump truck.

10. The method of claim 9, further comprising:
determining if a transmission of the articulated dump truck is placed in a forward gear; and
in response to the articulated dump truck being placed in a forward gear, failing to provide the activate signal to the braking system.

11. The method of claim 8, wherein the predetermined lateral tilt threshold has a value that is less than a value of the predetermined vertical tilt threshold.

12. The method of claim 9, further comprising:
locating a second tilt detector at the cargo body of the articulated dump truck;
detecting a second current lateral tilt at the cargo body; and
activating the fluid release valve in response to the second current lateral tilt exceeding a predetermined second lateral tilt threshold, thereby releasing the fluid from the piston.

13. A method for vehicle tip-over prevention for a load carrying vehicle, comprising:
providing a vehicle including a forward axle, a rearward axle, a chassis, a braking system, and a liquid cargo body;
locating a tilt detector at the chassis of the vehicle at a location below at least a portion of the liquid cargo body, wherein the tilt detector is configured to detect a current tilt; and
automatically activating the braking system of the vehicle in response to the current tilt exceeding a predetermined tilt threshold.

14. The method of claim 13, wherein the liquid cargo body is one of a mixer barrel and a fluid storage tank.

15. The method of claim 14, further comprising:
mounting a second tilt detector to the forward axle of the vehicle, wherein the second tilt detector is configured to detect a second current tilt; and
activating the braking system of the vehicle in response to the second current tilt exceeding a predetermined second tilt threshold.

16. The method of claim 15, further comprising:
mounting a third tilt detector to the rearmost axle of the vehicle, wherein the third tilt detector is configured to detect a third current tilt, wherein the current tilt, the second current tilt, and the third current tilt are lateral tilts; and
activating the braking system of the vehicle in response to the third current tilt exceeding a predetermined third tilt threshold.

17. The method of claim 16, wherein the predetermined tilt threshold, the predetermined second tilt threshold, and the predetermined third tilt threshold are selected from the range of 1 to 3 degrees of lateral tilt.

18. The method of claim 13, further comprising:
activating an alarm in response to the current tilt exceeding the predetermined tilt threshold, wherein activating the braking system further comprises engaging a parking brake of the vehicle; and
deactivating the alarm and disengaging the parking brake in response to the current tilt being less than the predetermined tilt threshold.

19. A tip-over prevention system for a vehicle, comprising:
a tilt detector operably coupled to a rear axle of the vehicle, wherein the tilt detector is configured to detect a current tilt;
a tilt controller in electronic communication with the tilt detector and a braking controller, wherein the braking controller is configured to activate a braking system of the vehicle;
wherein the tilt controller is configured to determine if the current tilt exceeds a preset tilt threshold; and
wherein in response to the tilt controller determining the current tilt exceeds the preset tilt threshold, the tilt controller is configured to signal the braking controller to activate the braking system of the vehicle.

20. The system of claim 19, wherein the vehicle is an articulated dump truck, wherein the current tilt is a current lateral tilt, wherein the tilt detector is further configured to detect a current vertical tilt, wherein the tilt controller is configured to determine if the current vertical tilt exceeds a preset vertical tilt threshold, and wherein the tilt controller is further configured to signal the braking controller to activate the braking system in response to the current vertical tilt exceeding the preset vertical tilt threshold.

21. The system of claim 19, further comprising:
a fluid driven piston configured to raise a cargo body;
a fluid release valve in fluid communication with the piston;
wherein the current tilt is a current lateral tilt;
a second tilt detector located at the cargo body, wherein the second tilt detector is configured to detect a second current lateral tilt, and wherein the second tilt detector is in communication with a second tilt controller; and
wherein the second tilt controller is configured to send an activation signal to an actuator of the fluid release valve in response to the second tilt controller determining that the second current lateral tilt exceeds a second preset tilt threshold.

22. The system of claim 19, wherein the tilt controller is placed in electronic communication with a drive controller of the vehicle, wherein the tilt controller is configured to determine if the vehicle is in a forward gear, and wherein the tilt controller is configured to abstain from signaling the braking controller to activate in response to the vehicle being placed in a forward gear.

23. The system of claim 19, wherein at least one of the tilt controller and tilt detector is connected to a power source which only provides power when the vehicle is placed in a reverse gear.

24. The system of claim 20, wherein the tilt detector is an inclinometer, wherein the preset tilt threshold is an angle selected from the range of 1 to 3 degrees of tilt, and wherein the vertical tilt threshold is an angle selected from the range of 12 to 35 degrees of tilt.

25. The system of claim 21, further comprising a cargo body position sensor configured to detect if the cargo body is in a lowered position.
